(19) United States
(12) Patent Application Publication
(10) Pub. No.: US 2007/0276695 A1
(43) Pub. Date: Nov. 29, 2007

(54) HEALTH CARE PAYMENT SYSTEM AND METHOD

(76) Inventor: Daniel M. Lieberman, Phoenix, AZ (US)

Correspondence Address: WEISS & MOY PC, 4204 NORTH BROWN AVENUE, SCOTTSDALE, AZ, 85251, US

(21) Appl. No.: 11/420,678

(22) Filed: May 26, 2006

(51) Int. Cl. G06Q 10/00; G06Q 40/00; G07G 1/14

(52) U.S. Cl. 705/2; 705/40; 705/14

(57) ABSTRACT

A system and method for payment of health care costs. A host operates a web-based marketplace that may be accessed by a plurality of patients and health care providers. In one embodiment, patients may search for health care providers at the marketplace, utilizing one or more of a plurality of criteria, including price. In one embodiment, payments by patients to health care providers may be made using funds from a health savings account.

### RELATED APPLICATIONS

This application claims priority to corresponding applications: U.S. Ser. No. 60/731,801, filed Oct. 31, 2005, and U.S. Ser. No. 11/215,656 filed Aug. 30, 2005.

### FIELD OF THE INVENTION

The present invention relates to health care payment systems and methods.

### BACKGROUND OF THE INVENTION

Health care costs and spending continue to rise in the U.S. In 2004, health spending by privately insured Americans increased by 8.2 percent. For that same year, medical costs grew nearly four times faster than the growth of wages. According to data from the U.S. Census Bureau, 45 million people (representing approximately 15% of the population) were uninsured in 2003.

The cost of most goods and services used in healthcare is determined by contractual rates negotiated between insurance companies and providers. Since the reimbursement is made by the insurance companies, as a third party, there has been little role for consumerism in keeping down costs. Thus, patients have not been motivated to seek out less expensive alternatives. This distorted marketplace, in which fees are set indirectly by third party players and not based on supply and demand, has become problematic. Due to inefficiencies in the market, the price of healthcare rises every year far faster than inflation. In addition, there is now considerable friction between providers, insurers, and consumers.

The increasing cost of health care in the United States in particular creates problems for all participants in the system. For individuals with insurance, the rising cost of health care is expressed in the form of higher insurance premiums, deductibles, and co-pays. For those who lack insurance, the rise in health care costs is experienced directly.

From the point of view of the health care provider, there is generally a need to deal with multiple insurers, each having different rate structures and paperwork requirements. It is not uncommon for a health care provide to spend 30% or so of its overhead on insurance-related administration.

Health Savings Accounts (“HSA's”) may be used to hold pre-tax dollars, to be used by an individual in a high deductible health plan to pay certain non-covered expenses, such as deductibles and co-pays. Under the legislation, banks, credit unions, insurance companies, and certain others may serve as an HSA trustee or custodian. HSA's, as currently structured, are not intended to be used as a substitute for insurance and, indeed, are only available to persons who are covered by a high deductible health plan. In addition, the record-keeping burden with respect to payments from the account rests with the individual, who must be prepared to show, if audited, that disbursements from the account were proper.

There is a continuing need for systems and methods that may further contribute to a lowering of the cost of health care to the patient and/or the cost of insurance compliance to the health care provider, that may increase competition in the healthcare marketplace, and/or that may provide other benefits. Embodiments of the present invention satisfy one or more of these needs and provide other, related, advantages.

### SUMMARY OF THE INVENTION

In accordance with an embodiment of the present invention, a method for improving health care transactions is disclosed. The method comprises: a host operating a web-based marketplace; providing a database identifying a plurality of health care providers; wherein at least one of the health care providers is a doctor providing treatment services; wherein the database is searchable at the marketplace by a patient based on a plurality of criteria; wherein at least one of the plurality of criteria is a price for one of goods and services provided by the plurality of health care providers, including the doctor; facilitating receipt of payment by one of the plurality of health care providers from the patient for one of goods and services provided by the health care provider to the patient; and facilitating electronic communication concerning the payment by the patient to the health care provider to a location designated by at least one of the host and the patient.

In accordance with another embodiment of the present invention, a method for improving health care transactions is disclosed. The method comprises: a host operating a web-based marketplace; providing a database identifying a plurality of health care providers; wherein the database is searchable at the marketplace by a patient based on a plurality of criteria; wherein at least one of the plurality of criteria is a price for one of goods and services provided by the plurality of health care providers; facilitating a change by the health care provider in the price disclosed to the patient at the marketplace; facilitating receipt of payment by one of the plurality of health care providers from the patient for one of goods and services provided by the health care provider to the patient; wherein the payment is made from a health savings account; facilitating electronic communication concerning the payment by the patient to the health care provider to a location designated by the host; and facilitating electronic communication concerning the payment by the patient to the health care provider to a location designated by the patient.

In accordance with a further embodiment of the present invention, a method for improving health care transactions is disclosed. The method comprises: a host operating a web-based marketplace; providing a database identifying a plurality of health care providers; wherein the database is searchable at the marketplace by a patient based on a plurality of criteria; wherein at least one of the plurality of criteria is a price for one of goods and services provided by the plurality of health care providers; facilitating a change by the health care provider in the price disclosed to the patient at the marketplace; facilitating receipt of payment by one of the plurality of health care providers from the patient for one of goods and services provided by the health care provider to the patient; wherein the payment is made from a health savings account; facilitating electronic communication concerning the payment by the patient to the health care provider to a location designated by the host; facilitating electronic communication concerning the identity of the one of goods and services provided by the health care provider to the patient to a location designated by one of the host and the patient; facilitating electronic communication concerning the payment by the patient to the health care provider to a location designated by the patient; and further comprising facilitating creation of an electronic medical record concerning the patient containing information concerning a plurality of services provided by at least one health care provider identified by the patient from the marketplace.

### BRIEF DESCRIPTION OF THE DRAWINGS

FIG. 1 is a block diagram illustrating a health care payment system consistent with an embodiment of the present invention.

FIG. 2 is an image of a homepage of a web-based healthcare marketplace consistent with an embodiment of the present invention.

FIG. 3 is an image of a page of a web-based healthcare marketplace consistent with an embodiment of the present invention.

FIG. 4 is an image of a page of a web-based healthcare marketplace consistent with an embodiment of the present invention.

FIG. 5 is an image of a page of a web-based healthcare marketplace consistent with an embodiment of the present invention.

### DETAILED DESCRIPTION OF THE PREFERRED EMBODIMENTS

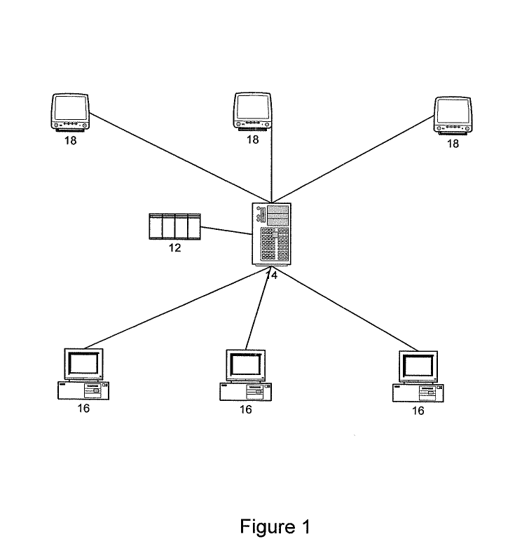

Referring to FIG. 1, the main actors in a system 10 that may be utilized to practice embodiments of the present invention are illustrated. Host 12 operates a dynamic, web-based healthcare marketplace 14, which may be accessed by patients 16 for purposes of making health care purchases from providers 18.

In one embodiment, the patients 16 maintain health savings accounts (“HSA's”), and the purchases they seek to make will be funded at least in part by funds in an HSA. The providers 18 may be doctors, providers of health-care related goods, or providers of health care related services. In one embodiment, a patient 16 may access his or her HSA via the marketplace 14, for purposes of checking account balances, transferring funds, and/or making a payment.

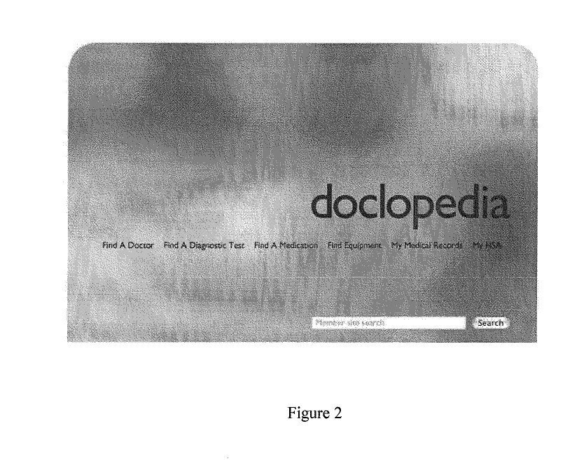

In one embodiment, the web-based marketplace 14 provides purchasing information for a plurality of health-care related categories. Examples of such categories include doctors, drugs, durable goods, and diagnostic tests. Other categories may also be utilized, as desired. Referring to FIG. 2, an example of a home page of a marketplace 14 is provided. As shown in FIG. 2, from the homepage, a user may be permitted to search for a doctor, a diagnostic test, a medication, and/or equipment.

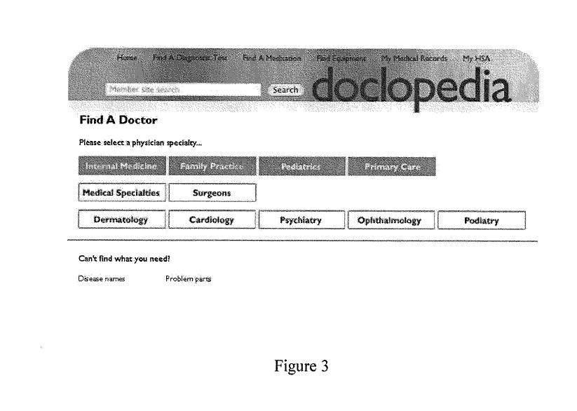

Referring now to FIG. 3, an example is provided of a search page on the web-based marketplace 14 which is intended to facilitate a search by a patient 16 for a doctor. In this embodiment, it can be seen that after clicking on “doctor” on the home page (see FIG. 2), a patient 16 can be provided with a plurality of selections for doctors according to specialty types, including internal medicine, family practice, pediatrics, primary care, dermatology, cardiology, etc.

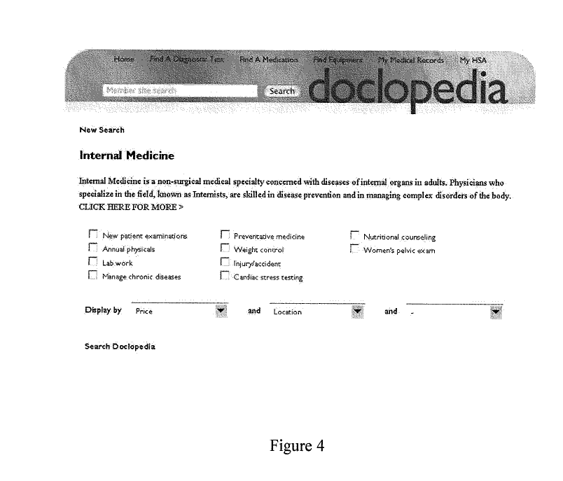

Referring now to FIG. 4, a patient 16 selecting one of the specialties, in this example “Internal Medicine,” may be presented with another set of choices to assist the search. For example, a patient 16 may be prompted to select a particular service needed, including for example a new patient examination, an annual physical, managing chronic disease, etc.

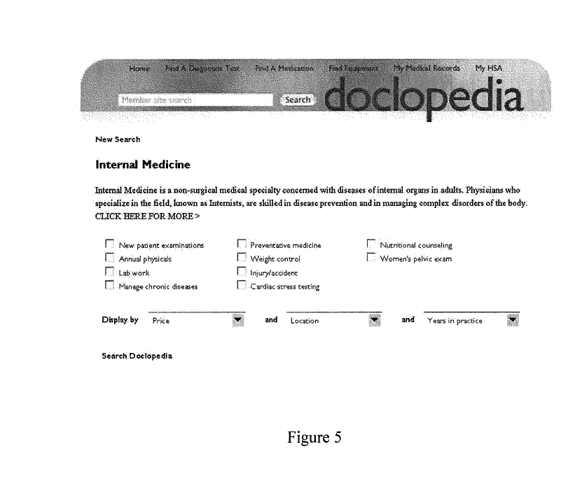

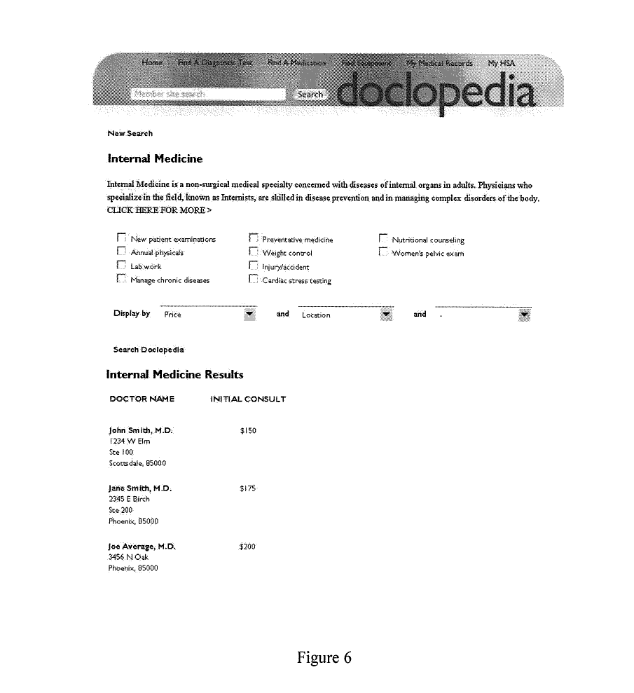

Referring to FIG. 5, it can be seen that a patient 16 may use one or more of a plurality of criteria to search for a particular doctor, in this case within the specialty of internal medicine. As shown by way of example, the searchable criteria may include price, the location of the doctor's office, and/or the number of years the doctor has been in practice.

As shown in FIG. 6, a patient 16 has searched for an internal medicine doctor utilizing price and location as search criteria. The search results displayed on the page including doctor names, addresses, and prices charged for an initial consultation.

With respect to the disclosure by doctors of the price they will be charging for their services, several issues should be noted. Such disclosure can permit a patient 16 to select a doctor based on price, contributing to the creation of improved competition in healthcare. Price may be expressed directly as shown in FIG. 6, or indirectly by, for example, pegging it multiples of the Medicare fee schedule.

In one embodiment, doctors may access the marketplace 14 to periodically change the price they charge for one or more of their services. For example, a doctor whose fee for a particular service is currently set at 150% of the Medicare fee schedule and who has openings in his clinic for new patient, may choose to log on to the web site and lower the fee to 120%. Similarly, another doctor whose clinic is at or approaching full capacity may want to increase her fees from 110% to 130%.

Referring now to FIG. 3, prices for health-care related services that may be provided by health care providers who are not doctors, such as an MRI scan, may also be searchable on the web-based marketplace 14. For example, if a patient 16 requires an MRI scan, the patient 16 may search the marketplace 14 for locations of offices where the scan may be obtained, and the anticipated charges. The patient 16 is then free to choose the imaging center closest to her house, or perhaps travel across the city to an underutilized scanner which has lowered charges in an effort to attract more business. Again, it can be seen that use of the marketplace as herein described can facilitate the creation of a dynamic health care marketplace.

Patients 16 may pay for services or goods purchased from a provider 18 that the patient 16 has located at the web-based marketplace in a variety of manners. In one embodiment, the patient 16 may use a debit type of card that is tied to the patient 16's HSA. In this embodiment, the use of the card triggers a communication to the host 12 of certain information relating to the transaction, including one or more of the patient 16's name, the identity of the good or service provided, the date the good or service was provided, and the price paid. With respect to the identity of the good or service provided, the provider 18 may utilize the CPT and/or ICD-9 code and/or some other coding system, so that the information can be characterized and communicated in a uniform manner. In this manner, in a single, paperless, transaction, payment is made to the provider 18, and coding information is transmitted from the provider 18 to the host 12.

A debit card utilized by a patient 16 as herein described may be issued by the host 12, which may also be a bank, or may be issued by another party, such as a financial institution.

A benefit to the use of a debit type card as herein described is that it may facilitate the generation and delivery to the patient 16 of an annual summary of health care expenditures for tax purposes, particularly where such purchases are made from an HSA. Where the CPT or ICD-9 coding systems are used, such a summary may be particularly useful and authoritative in resolving any inquiry regarding the propriety of the use of HSA funds for such expenditures, or otherwise to address deductibility issues.

Access to funds from an HSA may be permitted other than through the use of a debit card. For example, a patient 16 may provide account information regarding the HSA to the health care provider 18. Following provision of goods and/or services to a patient 16, the health care provider 18 may obtain payment directly from the HSA utilizing the account information.

The host 12, through its web-based marketplace 14, may also facilitate the creation of personal electronic medical records. Such records may be created from one or more sources, including for example from the information communicated to the host 12 and/or patient 16 (or other designated entity) following use by a patient 16 of a debit-type card or other form of payment in connection with a purchase from a provider 18 as herein described. Such information may include a listing of treatments the patient has received, diagnoses, medications, and allergies. In addition, other than through the use of a debit type card, the patient 16 may choose to add to his or her medical record by inputting information concerning past medical history, family history, social history, etc. It may also be desired to facilitate entry by a provider 18 of information into a patient's medical record.

To address privacy concerns, it may be desired to provide that the electronic medical record is only stored on the patient 16's home computer or other location designated by the patient 16. In such instance, a patient 16 could print out a copy of the medical record in connection with a visit to a particular provider 18, download the record to a PDA, to a patient data chip, or otherwise as needed. In another embodiment, the personal electronic medical record may be accessed via the web-based marketplace 14. Preferably, in this embodiment, access would be restricted by a password-protected entry.

In one embodiment, providers 18 receive direct payment from a patient 16 for the full amount of a particular service or good provided. As noted above, in one embodiment, such payment can be made by a patient 16 presenting a provider 18 with a debit type card, tied to an HSA. There are a number of advantages associated with such a method. These include the elimination of some or all of the overhead associated with relationships between providers 18 and insurers, relating to specialized billing and other procedures mandated by one or more insurers. They also include the elimination of the need to negotiate rates with an insurer, rather than the provider 18 directly setting rates based on, among other things, marketplace considerations.

The host 12 may obtain revenue from its operation of the web-based marketplace in a number of different ways. For example, the host 12 may elect to charge a per-transaction fee, whether in a fixed amount or in the form of a percentage of the amount of the transaction, for purchases by a patient 16 from a provider 18. For example, the host 12 may charge a fee to the provider 18, including for example a percentage (e.g., between 3% and 6%) of the purchase transaction, or the host 12 may charge a fixed, per-transaction fee. In addition or in the alternative, a percentage or fixed fee may be charged to the patient 16.

In addition, the host 12 may permit advertising on its web-based marketplace. Such advertisements can be specifically targeted to certain types of patients 16. For example, where a patient 16 seeks information regarding cardiac physicians in the area, the patient 16 could then be presented with advertising information regarding medications and services that would be of particular interest to a person with a heart condition. Advertisements may also be specific to a patient 16's physical location, age, sex or other desired criteria.

In one embodiment, the host 12 may choose to license one or more third parties, including for example insurers, employers, banks, etc., to be able to make the web-based marketplace available to a particular group of users.

While the invention has been particularly shown and described with reference to preferred embodiments thereof, it will be understood by those skilled in the art that the foregoing and other changes in form and details may be made therein without departing from the spirit and scope of the invention.

I claim:

1. A method for improving health care transactions comprising:
a host operating a web-based marketplace;
providing a database identifying a plurality of health care providers;
wherein at least one of the health care providers is a doctor providing treatment services;
wherein the database is searchable at the marketplace by a patient based on a plurality of criteria;
wherein at least one of the plurality of criteria is a price for one of goods and services provided by the plurality of health care providers, including the doctor;
facilitating receipt of payment by one of the plurality of health care providers from the patient for one of goods and services provided by the health care provider to the patient; and
facilitating electronic communication concerning the payment by the patient to the health care provider to a location designated by at least one of the host and the patient.

2. The method of claim 1 wherein the payment is made from a health savings account.

3. The method of claim 1 further comprising facilitating electronic communication concerning the identity of the one of goods and services provided by the health care provider to the patient to a location designated by the host.

4. The method of claim 1 further comprising facilitating electronic communication concerning the identity of the one of goods and services provided by the health care provider to the patient to a location designated by the patient.

5. The method of claim 1 wherein the plurality of criteria further comprises two or more of a physical location of the health care provider, sex of the health care provider, a specialty of the health care provider.

6. The method of claim 1 further comprising facilitating creation of an electronic medical record concerning the patient containing information concerning a plurality of services provided by at least one health care provider identified by the patient from the marketplace.

7. The method of claim 6 wherein the electronic medical record is delivered to a personal computer owned by the patient.

8. The method of claim 6 wherein the electronic medical record is accessible via the marketplace.

9. The method of claim 1 wherein the price is communicated as a percentage of a multiple of the Medicare fee schedule.

10. The method of claim 1 wherein the price is communicated directly.

11. The method of claim 1 further comprising facilitating a change by the health care provider in the price disclosed to the patient at the marketplace.

12. The method of claim 1 further comprising facilitating communication to a location designated by the patient of information concerning purchases of goods and services from health care providers for the period of a single tax year.

13. The method of claim 6 further comprising facilitating the addition of information by the patient to the electronic medical record.

14. The method of claim 1 further comprising facilitating advertisement on the marketplace by at least one advertiser.

15. The method of claim 14 wherein the step of facilitating advertisement further comprises facilitating advertisement that is selected for display to a particular patient based on at least one criteria.

16. The method of claim 15 wherein the at least one criteria is an identity of a specialty of a health care provider that is being searched by the patient at the marketplace.

17. The method of claim 1 further comprising facilitating payment by the health care provider to a designee of the host.

18. The method of claim 17 wherein the payment is a percentage of the payment from the patient to the health care provider.

19. A method for improving health care transactions comprising:
a host operating a web-based marketplace;
providing a database identifying a plurality of health care providers;
wherein the database is searchable at the marketplace by a patient based on a plurality of criteria;
wherein at least one of the plurality of criteria is a price for one of goods and services provided by the plurality of health care providers;
facilitating a change by the health care provider in the price disclosed to the patient at the marketplace;
facilitating receipt of payment by one of the plurality of health care providers from the patient for one of goods and services provided by the health care provider to the patient;
wherein the payment is made from a health savings account;
facilitating electronic communication concerning the payment by the patient to the health care provider to a location designated by the host; and
facilitating electronic communication concerning the payment by the patient to the health care provider to a location designated by the patient.

20. A method for improving health care transactions comprising:
a host operating a web-based marketplace;
providing a database identifying a plurality of health care providers;
wherein the database is searchable at the marketplace by a patient based on a plurality of criteria;
wherein at least one of the plurality of criteria is a price for one of goods and services provided by the plurality of health care providers;
facilitating a change by the health care provider in the price disclosed to the patient at the marketplace;
facilitating receipt of payment by one of the plurality of health care providers from the patient for one of goods and services provided by the health care provider to the patient;
wherein the payment is made from a health savings account;
facilitating electronic communication concerning the payment by the patient to the health care provider to a location designated by the host;
facilitating electronic communication concerning the identity of the one of goods and services provided by the health care provider to the patient to a location designated by one of the host and the patient;
facilitating electronic communication concerning the payment by the patient to the health care provider to a location designated by the patient; and
further comprising facilitating creation of an electronic medical record concerning the patient containing information concerning a plurality of services provided by at least one health care provider identified by the patient from the marketplace.
